(19) United States
(12) Patent Application Publication
(10) Pub. No.: US 2007/0266879 A1
(43) Pub. Date: Nov. 22, 2007

(54) METHOD AND SYSTEM FOR DRIVE REGULATION IN A PRINTING PRESS AND/OR PROCESSING MACHINE

(76) Inventors: Stephan Schultze, Lohr am Main (DE); Holger Schnabel, Wuerzburg (DE)

Correspondence Address: STRIKER, STRIKER & STENBY, 103 EAST NECK ROAD, HUNTINGTON, NY, 11743, US

(21) Appl. No.: 11/749,338

(22) Filed: May 16, 2007

(30) Foreign Application Priority Data
May 20, 2006 (DE) 10 2006 023 825.7

(51) Int. Cl. B41F 1/34

(52) U.S. Cl. 101/485

(57) ABSTRACT

In a method for drive regulation in a printing press and/or processing machine, in which a web of material is processed by processing devices and fed by feeder devices; a device for register regulation adjusts the processing devices, and a device for web feed regulation adjusts the feeder devices, and the device for register regulation adjusts at least one feeder device and the device for web feed regulation adjusts at least one processing device in a region, in particular a tension-regulated or expansion-controlled region, between two feeder devices, and to a corresponding drive system and a corresponding printing press.

### CROSS-REFERENCE TO A RELATED APPLICATION

The invention described and claimed hereinbelow is also described in German Patent Application DE 10 2006 023 825.7 filed on May 20, 2006. This German Patent Application, whose subject matter is incorporated here by reference, provides the basis for a claim of priority of invention under 35 U.S.C. 119(a)-(d).

### BACKGROUND OF THE INVENTION

The invention relates to a method and a system for drive regulation in a printing press and/or processing machine.

In printing press and/or processing machinees, in web-oriented processing, the web of material is typically affected by web-feeding and web-processing shafts or mechanisms. The web-feeding shafts generally provide for feeding of the web, and the web tension or expansion within the web of material is adjusted in a suitable way, for instance kept constant, by means of a web tension or tensile stress regulator, and do not process the material. They therefore need to be only relatively synchronized; in other words, there is no fixed angular relationship with the material.

The web-processing shafts process the web of material, which is for instance printed, stamped, cut, and so forth, and must therefore in general be absolutely synchronized; in other words, they must maintain a fixed angular relationship with the web of material. The web may comprise paper, fabric, cardboard, plastic, metal, rubber, or be in the form of film or foil, and so forth. During the web-processing processes, the web-processing shafts engage the web and thus influence not only the processing register or web register but also the feeding of the web of material.

Longitudinal register deviations are typically overcome by cylinder correction. The task of correction or register regulation is to compensate for mispositioning and to assure that the register is maintained. To that end, a processing shaft is for instance corrected by a suitable angular position, or in other words the distance between the two adjacent processing shafts is changed. Because of the uniform connection between the processing shaft and the material, the material is likewise displaced in slaved fashion. Thus initially there is no change in the processing done on the material; instead what happens is expansion or compression of the material, which is reversed again as a result of the constantly ongoing feeding of the material.

The change in web expansion in the region downstream of the corrected shaft also affects the following processing shafts. The result is register deviations in the following processing shafts, and these deviations are reversed only slowly, although automatically and without regulation. This effect of a correction on following processing shafts prevents the following processing shafts themselves from being corrected during this period. Dynamic optimization of the register regulation is not possible.

Changes in web-feeding shafts also cause changes in the processing register. Overall, corrections to web feeding or to the web register often lead to changes in the respective other variable. The web of material can therefore be changed by means of a register correction, which necessitates a web correction, which in turn can change the register, and so forth. In the worst case, feedback can occur that makes operation of the press or machine impossible. Regulators for both web feeding and register correction in the prior art can react only inadequately to the mutual interaction of these two variables.

In the article entitled “Schnelle Schnittregister-und Bahnzugkraftregelung für Rollendruckmaschinen” [“Fast Cutting Register and Web Tension Force Regulation for Roller-Type Printing Presses”] by Brandenburg et al, in Proceedings, SPS/IPC/Drives 2004, 15th Exposition and Congress, Nurnberg 2004, pp. 435-447, a method for adjusting a knife cylinder, located on the end of the web of material, by means of a tension regulator is described. No interaction with following processing shafts or feeding shafts is addressed.

### SUMMARY OF THE INVENTION

The object is therefore to disclose both a method and a system for drive regulation in printing press and/or processing machines that are better adapted to the interaction between web feed correction and register correction.

In keeping with these objects and with others which will become apparent hereinafter, in a method for drive regulation in an apparatus selected from the group consisting of a printing press, a processing machine, and both, comprising the steps of processing a web of material by processing devices; feeding the web of material by feeder devices; adjusting the processing devices by a device for register regulation; adjusting the feeder devices by a device for web feed regulation, said adjusting including adjusting at least one feeder device by the device for register regulation and adjusting at least one processing device for web feed regulation in a region between two of the feeder devices.

Another feature of the present invention resides, briefly stated, in a system for driving regulation in an apparatus selected from the group consisting of a printing press, a processing machine, and both, the system comprising processing devices for processing and feeding devices for feeding a web of material; a device for register regulation for adjusting said processing devices; a device for web feed regulation for adjusting said feeding devices; means for providing an operative connection between said device for register regulation and at least one of said feeding devices and operative connection between said device for web feed regulation in at least one of said processing devices in a region between two of said feeding devices.

As a result of the mutual coupling of the (register regulation and the web feed regulation and adjustment in a printing press and/or processing machine, in which a web of material is processed by processing devices, that is, in particular printing, cutting, and stamping mechanisms, and so forth, and fed by feeder devices, or in other words in particular tension rollers, the device for register regulation (or register regulator) also acts on at least one feeder device, and the device for web feed regulation (tension regulator or unregulated specified expansion) also acts on at least one processing device in a region, in particular tension-regulated or expansion-controlled, between two feeder devices.

The operative connection can be designed differently in each case, as will also be described in detail hereinafter. For instance, one regulator can have a pilot-controlling effect on the other regulator, on a regulator output of the other regulator, or on a final control element associated with a feeder device or processing device. By coupling the regulators, the respective controlled distances are linearized and decoupled, which leads to improved quality of the regulation. As a result, the accuracy can be increased, and spoilage or discards in general can be reduced. In the embodiment of the invention, the web tension can be embodied as either a closed control loop or as an unregulated adjustment of the web expansion; the specification of the expansion is typically done manually. The closed control loop includes a measuring member for detecting an actual value and a final control element for adjusting a set-point value. In the case purely of adjustment, no measuring member is necessary.

Advantageously, the device for register regulation pilot-controls process variables and/or control variables of the device for web feed regulation. Such process variables and/or control variables may for instance be a so-called fine gear calibration, an additive rotary speed, or an additive drive torque. In this exemplary embodiment, the register regulator acts to pilot-control the tension regulator or the expansion adjustment. This embodiment requires no changes to be made in the construction downstream of the tension regulator, such as summation devices or final control elements. The output of the register regulator is supplied to the tension regulator as a further parameter, which requires a change only to the tension regulator or its software.

Advantageously, the device for web feed regulation pilot-controls process variables and/or control variables of the device for register regulation. Such process variables and/or control variables may for instance be additive set-point position values or an additive speed. In this exemplary embodiment, the tension regulator acts to pilot-control the register regulator. This embodiment requires no changes to be made in the construction downstream of the register regulator, such as summation devices or final control elements. The output of the tension regulator is supplied to the register regulator as a further parameter, which requires a change only to the register regulator or its software. These two embodiments are therefore especially simple to implement, especially in existing systems.

It is expedient if the device for web feed regulation and/or the device for register regulation performs a stationary pilot control. In this embodiment, no dynamic compensation operations are taken into account, which makes the invention especially easy to implement.

It is especially expedient if in the pilot control, dynamic compensation operations are also taken into account. By adjusting a feed shaft or processing shaft, a brief change in the course of the web occurs, which in further processing fades exponentially over time. By taking these compensation operations into account, it is possible in particular to reduce or even entirely avoid errors in incident compensation operations. Also by this provision, the controlled systems are linearized, as a result of which the regulation can be speeded up and the settling time can be shortened. As a consequence, fewer discards are produced.

It is expedient if the parameters of the static and/or dynamic coupling are variable. This change can be done especially advantageously during press operation. Examples will be explained hereinafter.

Preferably, the parameters of the coupling are adapted to the web speed, in particular in proportion to a reciprocal value of the web speed. It is recommended that the time constant of the compensation operation, for instance, be adapted automatically and changed in accordance with its control parameters. The time constant is preferably made proportional to 1/web speed. This leads to a further improvement in the quality of regulation.

It is expedient if the parameters of the coupling are adapted to the web length, and in particular in proportion to the web length, and in particular the adaptation is fixedly set on the basis of the web length. Depending on the production or in other words the product made, the paper course, for instance, is variable (because of printing units that are in use or not in use). The result is a variable web length, which is known at the time production begins. From the known web length, the time constant of the compensation operation can be adapted. The time constant is assumed for instance to be proportional to the web length. The regulation can thus be improved still further.

Depending on the process, still other variables, such as acceleration, other physical parameters of the material to be processed, and/or of the web, and so forth may be used as variables to be adapted. In general, besides linear adaptation, still other proportionalities of adaptation are possible, such as square, cubic, and so forth, exponential, and logarithmic, and so forth.

A system according to the invention for drive regulation in a printing press and/or processing machine has an operative connection between the device for register regulation and at least one feeder device and an operative connection between the device for web feed regulation and at least one processing device. The system advantageously also has further means for performing one of the exemplary embodiments of the method according to the invention.

A printing press and/or processing machine of the invention, in particular a shaftless rotogravure printing press, has a system according to the invention for drive regulation.

Advantageously, the processing devices includes printing groups, and the feeder devices include tension mechanisms, in particular infeed mechanisms and/or delivery mechanisms.

Further advantages and features of the invention will become apparent from the description and the accompanying drawings.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic side view of one embodiment of a printing press of the invention; and

FIG. 2 is a schematic illustration of a preferred embodiment of the method of the invention.

### DESCRIPTION OF THE PREFERRED EMBODIMENTS

In the drawings, identical elements are identified by the same reference numerals.

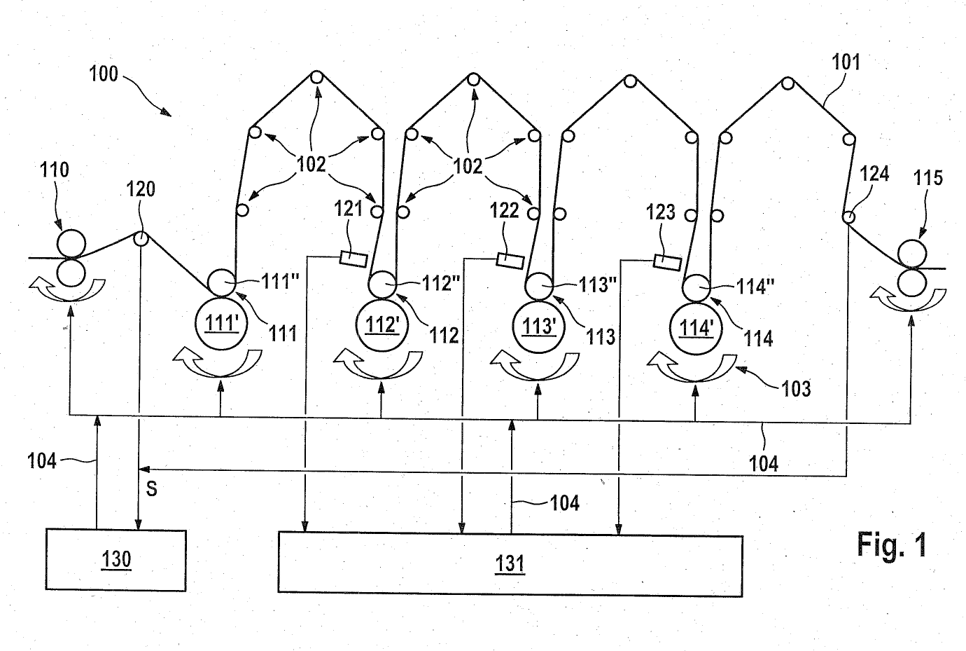

In FIG. 1, one preferred embodiment of the printing press of the invention is identified overall by reference numeral 100. A material to be printed upon, such as paper 101, is delivered to the press or machine via an infeed mechanism 110. The paper 101 is passed through printing groups 111, 112, 113, 114 and discharged again by a delivery mechanism 115. The infeed mechanisms, delivery mechanisms and printing groups 110 through 115 can be positioned, and in particular corrected in terms of the cylinder and the angle, which is indicated by semicircular arrows 103. For the sake of greater simplicity, not all the arrows have reference numerals. The printing groups 111 through 114 are located in a web tension-regulated region between the infeed mechanism 110 and the delivery mechanism 115.

The printing groups 111 through 114 each have a respective printing cylinder 111′ through 114′, against which a respective impression cylinder 111″ through 114″ is positioned with great pressure. The printing cylinders 111 through 114′ are driven individually and independently; the impression cylinders 111″ through 114″ are embodied freely rotatably. The infeed mechanism 110 and delivery mechanism 115 each have two contrary-motion cylinders that guide the paper 101. The infeed mechanism 110, delivery mechanism 115, and printing groups 111 through 114, together with the paper 101 passing through them, each form a frictionally connected unit.

In the web portions between the individual printing groups 111 through 114, the paper 101 is passed via rollers and devices not described in further detail, which are identified by reference numeral 102. For the sake of simplicity, not all the rollers and devices are provided with the reference numeral 102. These may in particular be deflection rollers, drying devices, cutting devices, and so forth.

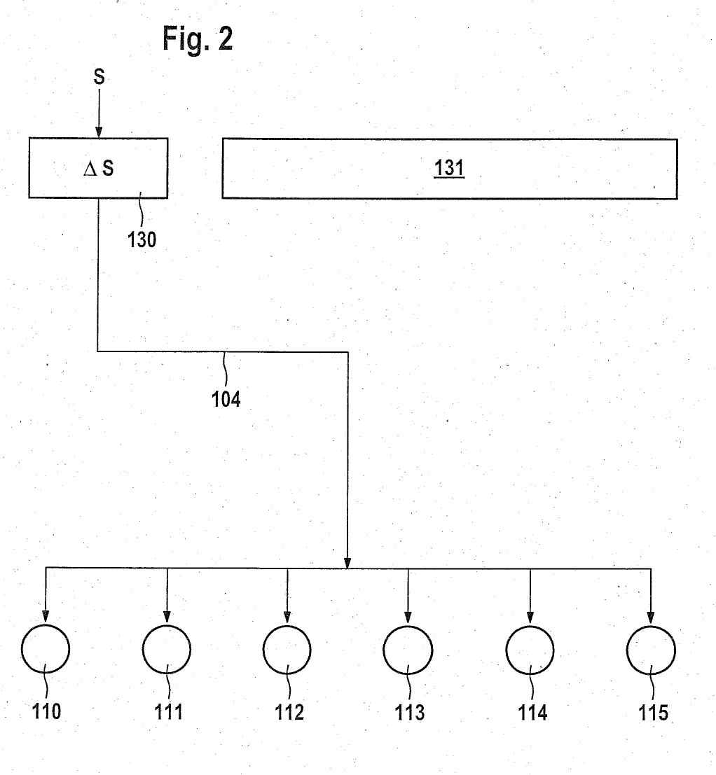

Between the infeed mechanism 110 and the first printing group 111, the web is provided with a sensor 120, and between the last printing group 114 and the delivery mechanism 115, it is provided with a sensor 124; the sensors are embodied as web tension sensors. Web tension values 1 detected by the sensors 120, 121 are delivered to a device for web feed regulation (tension regulator) 130. The tension regulator 130, as a function of the web tension values S, controls the positioning of the infeed mechanism 110 and the delivery mechanism 115 as well as, in accordance with the invention, controlling the positioning of the printing groups 111 through 114, as is shown in greater detail in FIG. 2. The operative connection is represented by an operative connection 104.

A sensor 121 is located in the web portion between the first printing group 111 and the second printing group 112; a sensor 122 is located in the web portion between the second printing group 112 and the third printing group 113; and a sensor 123 is located in the web portion between the third printing group 113 and the fourth printing group 114. The sensors 121 through 123 are embodied as mark readers. As the paper 101 passes through, each mark reader 121 through 123 detects when the printing mark (not shown), which is preferably applied by the first printing group 111, reaches that mark reader. The measurement value is delivered to a device for register regulation (register regulator) 131. Next, the position of the corresponding printing cylinder 112′ through 114′ is ascertained, and that measured value is likewise delivered to the register regulator 131. From this, any register deviation can be calculated (web/cylinder correction).

It is understood that the aforementioned regulators 130, 131 may be physically embodied by a common computer unit, in particular a computer.

The register deviations ascertained are used for positioning the printing groups 111 through 113 and according to the invention also for positioning the infeed mechanism 110 and the delivery mechanism 115. This is represented by the operative connection 104.

In FIG. 2, one preferred embodiment of the method of the invention is shown schematically. The preferred embodiment of the method of the invention is illustrated taking as an example the printing press described in conjunction with FIG. 1, in such a way that a web tension deviation detected by the sensor 120 is corrected by means of positioning the infeed mechanism 110, the delivery mechanism 115, and in a preferred embodiment of the invention all the processing devices or printing groups 111 through 114 that are located in the course of the processing downstream of the infeed mechanism 110. For one skilled in the art, it is understood how such a correction can be made by changing the position of the processing devices affected and of all the processing devices located downstream of the affected processing device in terms of the course of the processing.

In the first method step, a web tension deviation ΔS is ascertained by the tension regulator 130, by means of one of the sensors 120, 124 (FIG. 1). From the web tension deviation ΔS, the tension regulator calculates the necessary change in the adjustment, or in other words the necessary repositioning, of the infeed mechanism 110, and also in accordance with the example shown, corrections for all the downstream printing groups 111 through 114 and the delivery mechanism 115, to avoid a register deviation that could otherwise be caused by the correction of the infeed mechanism.

Next, the infeed mechanism 110, the printing groups 111 through 114, and the delivery mechanism 115 are repositioned in accordance with the calculated values, in order to correct the web tension deviation without causing a register deviation. By the described method, a web tension deviation can be corrected virtually simultaneously with a register deviation for every printing group. In contrast to a correction in the prior art, in a printing press of the invention it is not necessary for a web tension deviation or a register deviation to be corrected individually and in succession, since the fading time is reduced.

The invention also includes the reverse adjustment direction. For instance, to correct a register deviation of the printing group 114, the position of the printing groups 111 through 113 and of the infeed mechanism 110 is for instance changed. To that end, an angle correction, calculated by the register regulator 131, is made for all the printing groups 111 through 113 and the infeed mechanism 110 via the operative connection 104.

It is understood that in the drawings shown, only a particularly preferred embodiment of the printing press of the invention is shown. In addition, any other embodiment, in particular by means of a different arrangement or number of the printing groups and their construction and so forth, is conceivable without departing from the scope of the present invention.

It will be understood that each of the elements described above, or two or more together, may also find a useful application in other types of methods and constructions differing from the type described above.

While the invention has been illustrated and described as embodied in a method and system for drive regulation in a printing press and/or processing machine, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method for drive regulation in an apparatus selected from the group consisting of a printing press, a processing machine, and both, comprising the steps of processing a web of material by processing devices; feeding the web of material by feeder devices; adjusting the processing devices by a device for register regulation; adjusting the feeder devices by a device for web feed regulation, said adjusting including adjusting at least one feeder device by the device for register regulation and adjusting at least one processing device by the device for web feed regulation in a region between two of the feeder devices.

2. A methods as defined in claim 1, wherein said adjusting includes adjusting in the region selected from the group consisting of a tension-regulated region and an expansion-controlled region.

3. A method as defined in claim 1; and further comprising performing a pilot-control by the device for register regulation of parameters selected from the group consisting of process variables, control variables of the device for web feed regulation, and both.

4. A method as defined in claim 1; and further comprising performing a stationary pilot-control by the device for web feed regulation of parameters selected from the group consisting of process variables, control variables of the device for register regulation, and both.

5. A method as defined in claim 1; and further comprising performing a stationary pilot control by a device selected from the group consisting of the device for web feed regulation, the device for register regulation, and both.

6. A method as defined in claim 1; and further comprising performing a pilot control; and taking into account dynamic compensation operations in the pilot control.

7. A method as defined in claim 1; and further comprising providing of parameters selected from the group consisting of a static coupling, a dynamic coupling, and both, as a variable parameters.

8. A method as defined in claim 7; and further comprising adapting the parameters of the coupling to a web speed.

9. A method as defined in claim 8, wherein said adapting includes adapting the parameters of the coupling to the web speed in proportion to a reciprocal value of the web speed.

10. A method as defined in claim 8, wherein said adapting includes adapting the parameters of the coupling to a web length.

11. A method as defined in claim 10, wherein said adapting includes adapting the parameters of the coupling to the web length in proportion to the web length and fixedly setting the adaptation on a basis of the web length.

12. A system for driving regulation in an apparatus selected from the group consisting of a printing press, a processing machine, and both, the system comprising processing devices for processing and feeding devices for feeding a web of material; a device for register regulation for adjusting said processing devices; a device for web feed regulation for adjusting said feeding devices; means for providing an operative connection between said device for register regulation and at least one of said feeding devices and providing an operative connection between said device for web feed regulation and at least one of said processing devices in a region between two of said feeding devices.

13. A system as defined in claim 12, wherein said means for operative connection provide the operative connection in the region which is selected from the group consisting of a tensioned-regulated and an expansion-controlled region.

14. An apparatus selected from the group consisting of a rotor rotogravure printing press, flexographic printing press, and an offset printing press, in which a drive regulation is performed in accordance with a method, comprising the steps of processing a web of material by processing devices; feeding the web of material by feeder devices; adjusting the processing devices by a device for register regulation; adjusting the feeder devices by a device for web feed regulation, said adjusting including adjusting at least one feeder device by the device for register regulation and adjusting at least one processing device by the device for web feed regulation in a region between two of the feeder devices.

15. An apparatus selected from the group consisting of a rotogravure printing press, a flexographic printing press, and an offset printing press, said apparatus comprising a system for drive regulation including a system for driving regulation in an apparatus selected from the group consisting of a printing press, a processing machine, and both, the system comprising processing devices for processing and feeding devices for feeding a web of material; a device for register regulation for adjusting said processing devices; a device for web feed regulation for adjusting said feeding devices; means for providing an operative connection between said device for register regulation and at least one of said feeding devices and providing an operative connection between said device for web feed regulation and at least one of said processing devices in a region between two of said feeding devices.

16. An apparatus as defined in claim 15, wherein said processing devices includes printing groups, and said feeder devices include tension mechanisms.

17. An apparatus as defined in claim 16, wherein said tension mechanisms are mechanisms selected from the group consisting of infeed mechanisms, delivery mechanisms and both.
